(19) United States
(12) Patent Application Publication
(10) Pub. No.: US 2013/0278983 A1
(43) Pub. Date: Oct. 24, 2013

(54) MICROSCOPE SYSTEM HAVING A DYNAMIC HOLOGRAPHIC IMAGE REPRODUCTION UNIT

(71) Applicant: LEICA MICROSYSTEMS (SCHWEIZ) AG, Heerbrugg (CH)

(72) Inventor: Ulrich Sander, Rebstein (CH)

(21) Appl. No.: 13/866,053

(22) Filed: Apr. 19, 2013

(30) Foreign Application Priority Data
Apr. 20, 2012 (DE) 10 2012 206 594.6

(51) Int. Cl. G03H 1/26

(52) U.S. Cl. CPC G03H 1/268; G03H 1/26; G03H 1/265
USPC 359/23; 359/22

(57) ABSTRACT

A microscope system (100) is proposed, having at least one image acquisition unit (21) set up to acquire three-dimensional object image information, and having at least one image reproduction unit (30) set up for dynamic holographic reproduction of the three-dimensional object image information, in which system the at least one image reproduction unit (30) encompasses at least one image display unit (40) that comprises a photorefractive polymer (45) and that is set up for dynamic holographic reproduction of three-dimensional object image information by exposing the photorefractive polymer (45) in accordance with the three-dimensional object image information, and wherein the at least one image reproduction unit (30) comprises a viewing port (31), set up for viewing with both eyes of an observer, and an at least partly light-tight housing (33).

### CROSS REFERENCE TO RELATED APPLICATIONS

This application claims priority of German patent application number 10 2012 206 594.6 filed Apr. 20, 2012, the entire disclosure of which is incorporated by reference herein.

### FIELD OF THE INVENTION

The present invention relates to a microscope system, in particular a surgical microscope system, having an image acquisition unit set up to acquire three-dimensional object image information, and having an image reproduction unit set up for dynamic holographic reproduction of the three-dimensional object image information; and to a corresponding image reproduction unit.

### BACKGROUND OF THE INVENTION

In the field of surgical microscopy in particular, a need exists for investigating movable objects three-dimensionally. Stereomicroscopes, for example, have been known for this purpose for some time.

Overall, however, direct observation of objects with the eye or with corresponding stereomicroscopes will play an increasingly minor role in the future. Its place will be taken to an increasing extent by so-called “digital-optics” microscope systems, which image the object itself using digital methods or in which an optical image acquisition device has a digital image processing device associated with it. Completely electronic image transport from the imaging optic to the reproduction unit is increasingly occurring in this context.

Presentation of the respectively obtained three-dimensional object image information, for example using polarizing glasses, shutter glasses, and so-called lenticular displays, is likewise known in this context. EP 1 972 294 A1, for example, discloses a microscope in which an image made available by a display apparatus is imaged on a display screen. The image presented on the screen can be viewed stereoscopically by means of a secondary optical system.

Such systems often cannot, however, ensure a satisfactory spatial impression. Misperceptions in terms of visual physiology can thus occur.

The classic viewing system of a surgical microscope offers to the observer's right and left eye a real, magnified, physically existent intermediate image in the optical (Z) axis, so that the observer's eye can always bring the focal plane and convergence plane into congruence. The terms “intermediate image” and “intermediate image plane” are not exactly correct in this context. Instead, in a stereomicroscope the respective object (or an object space) is exactly physically imaged in a corresponding image space, so that the viewer can perform there a completely natural depth scan that corresponds to natural macroscopic viewing by the naked eye.

The constant convergence movements and the accommodation of the eye (depth scan) generate in the brain a visual-physiology stimulus that, in addition to transverse disparity (in the form of different image data in the “intermediate image plane” of the right and the left eye) additionally contributes to spatial perception.

A substantial disadvantage of the previously known digital-optics systems for three-dimensional presentation, conversely, is that the focal plane and the convergence plane are spatially fixed. The viewer's eye is generally forced to view on a two-dimensional display. This type of image perception does not correspond to natural visual physiology and therefore has a fatiguing effect. The aforesaid systems have therefore not yet always been able to achieve wide acceptance, at least in the sector of surgical microscopy. In some of the aforesaid systems the sequential presentation of the right/left stereo image pairs for the respectively right and left eye of the observer additionally proves to be disadvantageous.

A need therefore exists for corresponding improvements in microscope systems for dynamic reproduction of three-dimensional object image information.

### SUMMARY OF THE INVENTION

In light of this, the present invention proposes a microscope system having an image acquisition unit set up to acquire three-dimensional object image information, and having an image reproduction unit set up for dynamic holographic reproduction of the three-dimensional object image information, and a corresponding image reproduction unit. The image reproduction unit comprises at least one image display device including a photorefractive polymer, and is configured for dynamic holographic reproduction of the three-dimensional object image information by exposing the photorefractive polymer in accordance with the three-dimensional object image information. The image reproduction unit further comprises a viewing port configured to allow viewing of the at least one image display unit with both eyes of an observer, and an at least partly light-tight housing arranged to block stray light from the at least one image display device.

Preferred embodiments are the subject matter of the respective dependent claims and of the description which follows.

### ADVANTAGES OF THE INVENTION

It is proposed according to the present invention to equip an image reproduction unit of a microscope system, in particular of a surgical microscope system, with at least one image display device that comprises a photorefractive polymer. The image reproduction unit is capable of dynamic holographic reproduction of three-dimensional object image information by exposing the photorefractive polymer in accordance with the three-dimensional object image information. The three-dimensional object image information is furnished to the image reproduction unit by an image acquisition unit, preferably by a holographic image acquisition system, but also, for example, in the form of computer-generated hologram data. The image display apparatus allows an image having spatial depth to be reproduced electro-optically.

According to the invention, and as further explained below, the image reproduction unit comprises a viewing port, set up for viewing with both eyes of an observer, and an at least partly light-tight housing. One or more of such image reproduction units can be provided.

Advantageously, the image reproduction unit can be arranged remotely from the at least one image acquisition unit, e.g. remotely from a surgical site at a physical distance from an operating table, for example outside a sterile area or in a position that offers sufficient space, without disturbing the participants.

When “three dimensional object image information” is discussed in the context of this Application, what is to be understood thereby is all image information in optical and/or digital form that is suitable for indicating, at least in part, three-dimensional features of a object. Any additional information, for example spectral features such as color, temperature, and the like, can be contained in the three-dimensional object image information.

“Dynamic” image reproduction is to be understood, as opposed to “static” image reproduction, as image reproduction that encompasses at least to a certain extent the representation of movable objects in the form of a three-dimensional moving image display. “Dynamic” reproduction encompasses continuous or discontinuous refreshing of an image display device in suitable fashion, for example at a specific repetition frequency, in a manner corresponding to the motion of the respective object being investigated.

Lastly, the term “photorefractive” is intended to encompass all phenomena that bring about a change in the refractive index of a molecule and/or of a material upon illumination. It is known that, for example, photoionization, the generation and distribution of charge carriers (drift, diffusion, volume-related photovoltaic effects) and/or modulation of an electric field (Pockels effect) can play a role in photorefractive phenomena.

According to the present invention, a number of advantages are achieved as a result of equipping the at least one image display unit with a photorefractive polymer. Suitable polymers and their advantages are also described in detail, for example, in the article “Holographic Three-Dimensional Telepresence Using Large-Area Photorefractive Polymer,” by P.-A. Blanche et al. (Nature 468, 80-83).

It is known that in holography, in contrast to conventional imaging methods, not only intensity information (i.e. light amplitudes) but also phase information is obtained and transported. This phase information is recovered on the basis of interference phenomena in the form of interference patterns. Coherent light, usually a laser beam, that is spread by means of diverging lenses in order to achieve sufficient object illumination, is used for this.

Holography per se is known. It is based on interference effects between coherent light with which a object is irradiated (called the “reference wave”) and light that is reflected from the object (called the “object wave”). The resulting interference patterns are imaged onto a recording device, for example a (CCD) sensor. Techniques for reconstructing a corresponding three-dimensional image, for example in the context of transmitted-light holography, are also known and therefore will not be further discussed here.

Because the entire wave field in front of and behind the particular object being imaged is also reconstructed in the context of holography, the image can also be viewed from different directions.

The use according to the present invention of a photorefractive polymer allows all the advantages of holography to be utilized. In contrast to the methods according to the existing art, which are subjectively perceived as unnatural and are also objectively non-physiological, a spatial visual impression that has a natural effect is generated. This is reinforced by the fact that the viewer can move back and forth in the wave field and thereby view the particular object from different directions.

Unlike other three-dimensional presentation methods, holography represents an autostereoscopic imaging method, i.e. viewing does not require any additional viewing devices such as 3D glasses or head-mounted displays, which are known to be capable of producing fatigue phenomena and/or disorientation phenomena. Conventional static holograms can reproduce an information content of several terabytes of data and are known in a wide variety of sizes, with or without color reproduction, in the form of completely or partly parallactic imaging systems, and with differing depth reproduction.

The use of a photorefractive polymer also, however, overcomes the disadvantages of conventional holographic technologies. The known static holographic recording systems are due to their basic principles poorly suited for the microscopy of moving objects. Known dynamic holographic displays, however (for example acousto-optical, liquid-crystal, and microelectromechanical systems), for their part have little or no image persistence and must therefore be continually refreshed. A frequency of at least 30 Hz is needed in order to at least partly avoid flickering in this context. Because of the large quantities of data in the three-dimensional object image information, the maximum size of these conventional holographic displays is, as a result, very limited.

In contrast thereto, (partly) persistent images can be reversibly recorded by means of photorefractive polymers. Photorefractive polymers therefore allow slower image refresh frequencies than the systems previously explained. This solution can be achieved using inorganic photorefractive crystals only if they can be generated at the desired size. Photothermoplastic systems also cannot at present be satisfactorily used for dynamic presentation of holograms.

Photorefractive polymers allow the production of large-area, fast-reacting (dynamically reacting) holographic recording and reproduction media. For example, a hologram approx. 10×10 cm can be acquired therewith at a resolution of 1 mm in about two seconds. If short-pulse lasers are used for recording and reproduction, the holographic recording and reproduction system is almost vibration-insensitive and is suitable for use in clinical practice without additional control of vibration, noise, or temperature.

The recording of image data onto photorefractive polymers is based on the buildup of space-charge fields as a result of selective transport and capture of light-generated charges. Changes in refractive index that are induced by the electric fields occur on the basis of photorefractive effects. These are—unlike in photochemical processes—completely reversible; recorded object information can be “erased” by uniform illumination and/or by simply overwriting it.

An image acquisition unit can provide, by means of a suitable stereoscopic optic or by corresponding (holographic) image acquisition, three-dimensional object image information that transports both intensity information and phase information along the downstream transfer chain, for example in electronic form. A hologram that is ultimately displayed can also be a computer-generated hologram that furnishes hologram information reconstructed from three-dimensional object image information obtained in other ways, e.g. optically and/or in the form of image stacks.

The image display unit, which can also be a multicolor polymer display device as explained in detail below, can be mounted at a suitable location either in the vicinity of an object being investigated, for example on a surgical microscope, or also remotely therefrom.

It can be particularly advantageous in this context to enable remote transfer of the image data, and remote reproduction, for example in the form of a conference circuit. A transfer of the image information via Ethernet or other methods can, for example, be provided for, and can be used e.g. for telemedicine.

It is considered to be particularly advantageous to equip each image reproduction unit with two respective corresponding polymer image display units, thereby creating a stereoscopic presentation unit having separate viewing ports for each of the viewer's eyes. The three-dimensional image of the respective polymer system takes the place of the respective “intermediate image planes” of a visual-optics eyepiece system. A viewing capability of a conventional optical stereomicroscope system can thereby be simulated; this reduces adaptation difficulties for the user, and enables fatigue-free observation in accordance with natural visual physiology. This eliminates the disadvantages and visual-physiology shortcomings of a two-dimensional system.

Advantageously, exposure of the photorefractive polymer encompasses irradiation of an object beam and a reference beam from different irradiation angles onto the photorefractive polymer. Lens arrays that respectively permit focusing of the reference beam and object beam at discrete locations or focal points on the photorefractive polymer are usefully utilized for this. The reference beam and object beam thus become superimposed at the focal points so that corresponding interference patterns can be recorded.

Advantageously, illumination occurs in such a way that a pulsed laser holography recording system and a photorefractive polymer, in which each holographic pixel (hogel) can be written by means of a single nanosecond laser pulse, are used. It is possible to use in this context, for example, a pulsed laser system that furnishes six nanosecond laser pulses with a power output of 200 mJ per pulse at a frequency of 50 Hz.

A system that enables color hologram presentation is regarded as particularly advantageous. Color hologram presentation can contain a true-color and/or false-color presentation, for example to emphasize diagnostically relevant features.

It is known that a distinction can be made, depending on the colors that occur upon reconstruction of the holographic information, among white light holograms, holograms that cannot be reconstructed under white light, and true-color holograms.

True-color holograms can be generated using white-light lasers or by sequential exposure with color lasers. The recording and reproduction medium must be sensitive to all colors. Because light having different wavelengths and colors is diffracted to different degrees, the lasers used for reconstruction must be arranged at an angle to the medium which depends on the respective wavelength, so that the individual images are produced at the same location.

With particular advantage, an angle multiplexing method is used for color presentation. Here up to three different holograms are written into the photorefractive polymer at different angles, and read out, for example, by means of correspondingly colored LEDs (red, green, and blue for full-color presentation). Advantageously, particular reference beam angle differences are taken into account in order to avoid mutual influences among the colors during readout. Because the three holograms are recorded simultaneously, the recording time for color holograms does not exceed that for monochromatic holograms.

The system can be embodied as a partly or completely parallactic system. It is known that an impression of perspective in the human eye is achieved principally because of the horizontal separation of the eyes. An (exclusively) horizontally parallactic system is therefore sufficient for most 3D applications and offers speed advantages. Completely parallactic systems are required, however, in specific utilization sectors, for example in viewing systems in which viewing is intended to occur from all positions. The number of hogels required for completely parallactic system is the square of the number for an exclusively horizontally parallactic system.

An advantageous (surgical) microscope system comprises at least two image acquisition units and/or image reproduction units that are set up respectively to acquire and/or reproduce a hologram at mutually different acquisition angles and/or reproduction angles. An acquisition angle and/or reproduction angle corresponds here to a viewing angle onto an object being investigated.

Many surgical procedures are performed simultaneously by a principal surgeon and at least one assistant. The principal surgeon and assistants stand around an operating table. The position of the principal surgeon (and thus his angle of view) is referred to as the “0° position.” The position of an assistant standing opposite him is referred to as the “180° position.” The positions of a further assistant standing at right angles to the principal surgeon and to the first assistant are referred to as “90° positions.”

A configuration of this kind can also be implemented by the positioning of corresponding image acquisition and/or image reproduction units. For example, in a surgical microscope system that is arranged around an operating table, multiple image reproduction units can be arranged oppositely to or at a 90° angle from one another. The principal surgeon and assistant can then position themselves in accordance with their usual arrangement. Further image reproduction units can, however, additionally be provided. These can allow further assistants, students, or the like to follow the procedure as if they were on site in the position of the surgeon or of the assistant. The further image reproduction units can also be arranged at a physical distance from the operating table, for example outside a sterile area or in a position that offers sufficient space, without disturbing the participants.

A copolymer having a polymer chain and photorefractive side groups can be used with particular advantage as a photorefractive polymer. All known photorefractive materials are suitable in principle for use in the image display unit. In contrast to photorefractive crystals, as already mentioned, polymers are notable for particularly simple manufacture, since laborious crystal cultivation is not necessary.

A copolymer having a polyacrylic acid polymer chain and tetraphenyldiaminobiphenyl (TPD) and carbaldehyde aniline (CAAN) side groups is regarded as particularly advantageous for use in an image display unit. The content of TPD side groups advantageously exceeds that of CAAN side groups.

Advantageously, a plasticizer that facilitates an arrangement of the chromophores in the photorefractive space charge field is advantageously also used in a photorefractive polymer. The index modulation properties can be improved by adding fluorinated chromophores. Fullerene derivatives, for example, can also be used to improve sensitivity to the nanosecond pulses that are used.

Further indications as to an advantageously usable polymer, its properties, and its manufacture can be gathered, for example, from the previously mentioned publication of Blanche et al.

Be it noted that the use of the proposed system is not limited to the combination with a conventional surgical microscope, but is also equally suitable for equipping a microscope system having a special camera with two objectives. A stereo objective is also particularly suitable for use with a corresponding system, since it possesses corresponding focus, zoom, and convergence-angle properties. The two objectives can define a convergence angle and can also be installed at a more remote position from the surgical field than a surgical microscope, for example on a ceiling of an operating room.

It is particularly advantageous if the 3D presentation properties in a digital-optics microscope can be switched in and out, with the result that the microscope can then also be used as necessary as a conventional visual-optics binocular system.

Regarding the image reproduction unit likewise proposed according to the present invention, reference is made expressly to the features previously explained and their respective advantages.

Further advantages and embodiments of the invention are evident from the description and from the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment, and will be described in detail below with reference to the drawings.

### BRIEF DESCRIPTION OF THE DRAWING VIEWS

FIG. 1 is a schematic depiction of a microscope system according to a particularly preferred embodiment of the invention.

FIG. 2 is a schematic depiction of an image reproduction unit according to a particularly preferred embodiment of the invention.

FIG. 3 is a schematic depiction of exposure of a photorefractive polymer according to a particularly preferred embodiment of the invention.

### DETAILED DESCRIPTION OF THE INVENTION

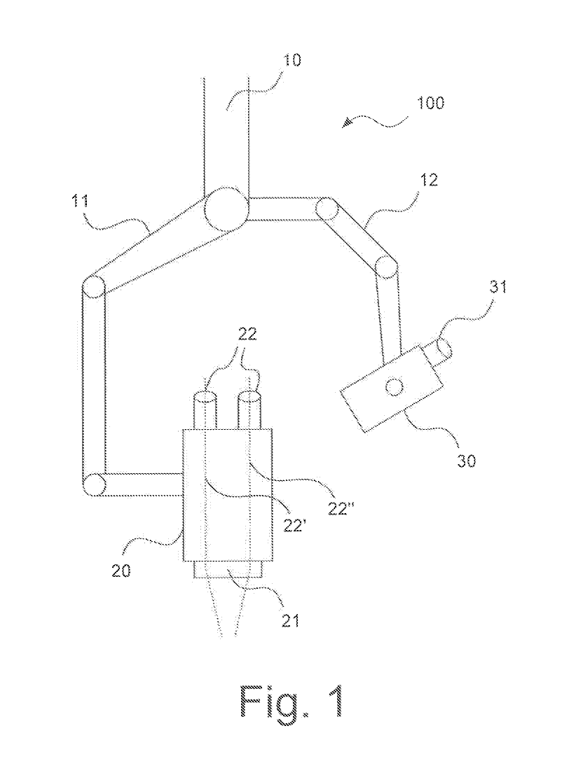

A microscope system according to a particularly preferred embodiment of the invention is depicted in FIG. 1 and labeled in its entirety as 100. Microscope system 100 is embodied, for example, as a ceiling-mounted surgical microscope system, and is fastened on a carrier arm 10 (not explained in further detail). A binocular stereomicroscope 20 that can possess, for example, an image acquisition unit 21 and eyepieces 22, is attached to a first pivot arm 11. The visual stereoscopic channels are labeled 22′ and 22″. Image acquisition unit 21 is set up to acquire three-dimensional object image data in the form of (conventional) optical and/or digital images and/or in the form of hologram data. It possesses for that purpose, for example, a main objective, a zoom system, an image sensing system, a documentation device, and/or a holographic scanning device. Additional image acquisition devices can be provided. An observer can visually observe, through a pair of eyepieces 22, an object arranged on the objective side of microscope 20.

An image reproduction unit 30 having a viewing port 31 is attached to a second pivot art 12. Although image reproduction unit 30 in FIG. 1 is depicted as being separate from stereomicroscope 20, image reproduction unit 30 can also be embodied as an integral constituent of microscope 20. Provision can also be made to furnish multiple image reproduction units 30, for example in the form of a so-called discussion arrangement, so as thereby to enable simultaneous observation by multiple viewers of an object being investigated. As mentioned, any number of image reproduction units 30 can be arranged locally or remotely, and/or so as to include specific angles.

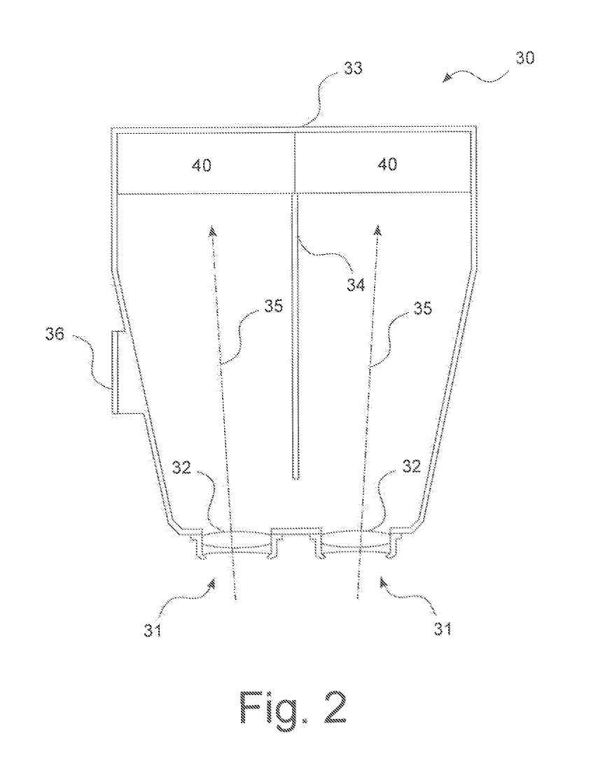

FIG. 2 shows an image reproduction unit according to a particularly preferred embodiment of the invention, which is labeled in its entirety as 30. The image reproduction unit possesses a viewing port 31, set up for viewing with both eyes, that can be equipped with corresponding optics 32, for example for diopter compensation and/or for magnification of a holographic image being viewed. Image reproduction unit 30 possesses an advantageously (partly) light-tight housing 33 in order to enable a visual impression with as little disruption as possible, free of stray light and room light.

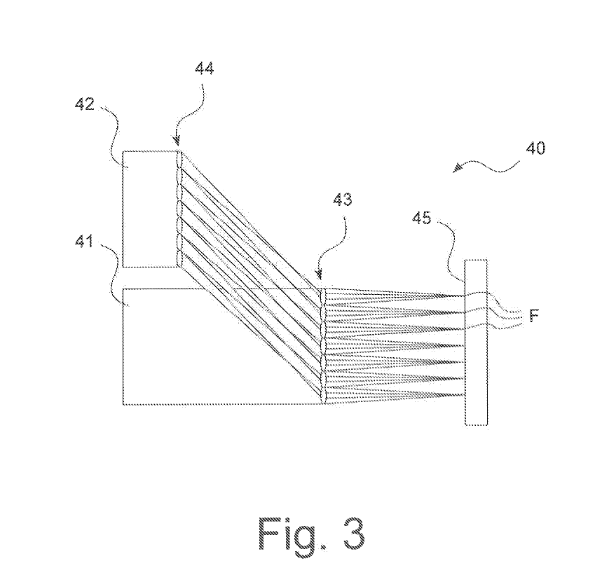

A partition wall 34 is provided in order to ensure undisturbed viewing with both eyes along viewing axes 35. Image reproduction device 30 possesses a fastening device 36 for attachment to, for example, a pivot arm 12. Polymer image display devices 40, which can be exposed in accordance with three-dimensional object image information from the side opposite to viewing port 31, for example as illustrated in FIG. 3, are provided for holographic reproduction of three-dimensional object image information.

FIG. 3 illustrates the exposure of a holographic polymer image display device, labeled in its entirety as 40, by an object beam 41 and a reference beam 42. Thanks to the use of a first lens array 43 and a second lens array 43, portions of the object beam and of the reference beam are focused respectively onto common, discrete focus positions F on a photorefractive polymer 45, with the result that the previously explained laser interference effects, and thus a three-dimensional visualization, respectively occur there.

### PARTS LIST

10 Carrier arm
11 First pivot arm
12 Second pivot arm
20 Stereomicroscope
21 Image acquisition device
22 Eyepieces
30 Image reproduction unit
31 Viewing port
32 Optic
33 Housing
34 Partition wall
35 Viewing axis
36 Fastening mount
40 Image display device
41 Object beam
42 Reference beam
43 First lens array
44 Second lens array
45 Photorefractive polymer
F Focal points
100 Microscope system

What is claimed is:

1. A microscope system (100) having at least one image acquisition unit (21) configured to acquire three-dimensional object image information, and having at least one image reproduction unit (30) configured for dynamic holographic reproduction of the three-dimensional object image information,
wherein the at least one image reproduction unit (30) comprises at least one image display device (40) including a photorefractive polymer (45), wherein the at least one image reproduction unit (30) is configured for dynamic holographic reproduction of the three-dimensional object image information by exposing the photorefractive polymer (45) in accordance with the three-dimensional object image information, and
wherein the at least one image reproduction unit (30) comprises a viewing port (31) configured to allow viewing of the at least one image display unit (40) with both eyes of an observer, and an at least partly light-tight housing (33) arranged to block stray light from the at least one image display device (40).

2. The microscope system (100) according to claim 1, wherein the at least one image reproduction unit (30) is arranged remotely from the at least one image acquisition unit (21).

3. The microscope system (100) according to claim 1, wherein the microscope system is a surgical microscope system.

4. The microscope system (100) according to claim 1, wherein the at least one image reproduction unit (30) is embodied as a stereoscopic presentation unit having two image display devices (40) each viewable by one eye of an observer.

5. The microscope system (100) according to claim 1, wherein the at least one image display unit (40) is configured to expose the photorefractive polymer (45) by imaging an object laser beam (41) and a reference laser beam (42) in a number of common positions (F) on the polymer (45).

6. The microscope system (100) according to claim 5, wherein the at least one image display unit (40) includes a respective lens array (43, 44) for imaging the object laser beam (41) and the reference laser beam (42).

7. The microscope system (100) according to claim 1, wherein the at least one image acquisition unit (21) is configured to acquire the three-dimensional object image information by irradiating at least one laser beam through an objective onto an object.

8. The microscope system (100) according to claim 7, wherein the image acquisition unit (21) is configured to furnish short laser pulses.

9. The microscope system (100) according to claim 5, wherein the image reproduction unit (30) is configured to furnish short laser pulses.

10. The microscope system (100) according to claim 1, wherein the at least one image acquisition unit (21) and the at least one image reproduction unit (30) are configured to respectively acquire and reproduce a monochrome hologram or a color hologram by means of angle multiplexing.

11. The microscope system (100) according to claim 1, wherein the at least one image acquisition unit (21) and the at least one image reproduction unit (30) are configured to respectively acquire and reproduce a completely or partly parallactic hologram.

12. The microscope system (100) according to claim 1, wherein the microscope system (100) comprises at least two image acquisition units (21) each configured to acquire a hologram at mutually differing acquisition angles.

13. The microscope system (100) according to claim 1, wherein the microscope system (100) comprises at least two image reproduction units (30) each configured to reproduce a hologram at mutually differing reproduction angles.

14. The microscope system (100) according to claim 12, wherein the microscope system (100) comprises at least two image reproduction units (30) each configured to reproduce a hologram at mutually differing reproduction angles.

15. The microscope system (100) according to claim 1, wherein the photorefractive polymer (45) comprises a polymer chain and photorefractive side groups.

16. The microscope system (100) according to claim 15, wherein the photorefractive polymer (45) comprises a polyacrylic acid polymer chain and tetraphenyldiaminobiphenyl side groups and/or carbaldehyde aniline side groups.

17. An image reproduction unit (30) for use in a digital-optics microscope system (100), the image reproduction unit comprising:
at least one image display unit (40) including a photorefractive polymer (45), the at least one image display unit (40) being configured for dynamic holographic reproduction of three-dimensional object image information by exposing the photorefractive polymer (45) in accordance with the three-dimensional object image information;
a viewing port (31) configured to allow viewing of the at least one image display unit (40) with both eyes of an observer; and
an at least partly light-tight housing (33) arranged to block stray light from the at least one image display unit (40).

18. The image reproduction unit (30) according to claim 17, wherein the image reproduction unit (30) can be switched off.
